(19) United States
(12) Patent Application Publication
(10) Pub. No.: US 2026/0189834 A1
(43) Pub. Date: Jul. 2, 2026

(54) WIND SHIELD FOR MICROPHONES

(71) Applicant: Harman International Industries, Incorporated, Samford, CT (US)

(72) Inventors: Peter Bowers, Northridge, CA (US); Steven Guzman, Northridge, CA (US); Bruce Ryan, West Hills, CA (US)

(21) Appl. No.: 19/006,356

(22) Filed: Dec. 31, 2024

(51) Int. Cl. H04R 1/08

(52) U.S. Cl. CPC H04R 1/086; H04R 2410/07

(57) ABSTRACT

A shield assembly arranged around an acoustic sensor may include an outer shell extending from an outer apex to a base and forming a dome-shape, the outer shell defining at least one perforation to allow air to flow therethrough, and an inner shell extending from an inner apex to the base inside of the outer shell, the inner shell creating a channel between the outer shell, inner shell, and base to receive airflow at the at least one perforation, wherein the at least one perforation and channel redirect air to protect a microphone arranged within the inner shell from external airflow and preserving sound pressure measurement integrity.

### TECHNICAL FIELD

Disclosed herein are wind shields for microphone assemblies.

### BACKGROUND

Acoustic sensors often detect the change of sound pressure around an equilibrium point, such as atmospheric pressure. Proper measurement of the sound pressure may depend on the equilibrium point remaining constant. However, atmospheric pressure may be affected by external factors such as weather and the presence of wind. Turbulence may cause localized static pressure to change, thus effecting sound pressure measurements.

### SUMMARY

A shield assembly arranged around an acoustic sensor may include an outer shell extending from an outer apex to a base and forming a dome-shape, the outer shell defining at least one perforation to allow air to flow therethrough, and an inner shell extending from an inner apex to the base inside of the outer shell, the inner shell creating a channel between the outer shell, inner shell, and base to receive airflow at the at least one perforation, wherein the at least one perforation and channel redirect air to protect a microphone arranged within the inner shell from external airflow and preserving sound pressure measurement integrity.

In another embodiment, the at least one perforation includes a plurality of first perforations and a plurality of second perforations, wherein the first perforations extend radially from the apex and wherein the second perforations are spaced from the first perforations, wherein when the airflow is received at at least one of the first perforations, the airflow travels through the channel and out of at least one of the second perforations, and wherein when the airflow is received at at least one of the second perforations, the airflow travels through the channel and out of at least one of the first perforations.

In one example, the second perforations are spaced from the first perforations and include a plurality of spaced holes around the base forming a ring of perforations.

In another embodiment, the first perforations are defined at an angle to facilitate receiving the airflow.

In one example, the first perforations each form a quadrilateral.

In another example, the first perforations include a plurality of rows of perforations, each spaced from the next row radially downward from the apex.

In another embodiment, the inner shell defines a plurality of inner perforations at the inner apex to allow sound to pass to the microphone.

In one example, the base maintains the outer shell and inner shell in fixed relationship to each other to form the channel therebetween.

A shield assembly arranged around an acoustic sensor may include an outer shell extending from an outer apex to a base and forming a dome-shape, the outer shell defining a plurality of perforations, including a plurality of first perforations and a plurality of second perforations, wherein the first perforations extend radially from the apex and are defined at an angle within the outer shell to receive airflow from the environment external to the outer shell, wherein the second perforations are spaced from the first perforations and include a plurality of spaced holes around the base forming a ring of perforations, and wherein when the airflow is received at at least one of the first perforations, the airflow flows out of at least one of the second perforations, and wherein when the airflow is received at at least one of the second perforations, the airflow flows out of at least one of the first perforations.

In another embodiment, an inner shell extending from an inner apex to the base inside of the outer shell, the inner shell creating a channel between the outer shell, inner shell, and base to receive airflow at the first and second perforation of the outer shell to protect the sensor arranged from external airflow and preserving sound pressure measurement integrity.

In one example, the inner shell defines a plurality of inner perforations at the inner apex to allow sound to pass to the sensor.

In another embodiment, the base maintains the outer shell and inner shell in fixed relationship to each other to form the channel therebetween.

In one example, the first perforations each form a quadrilateral.

In another embodiment, the first perforations include a plurality of rows of perforations, each spaced from the next row radially downward from the apex.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a perspective top view of a shield assembly;

FIG. 2 illustrates a perspective cross-sectional view of the shield assembly of FIG. 1;

FIG. 3 illustrates another perspective cross-sectional view of the shield assembly of FIG. 1;

FIG. 4 illustrates another perspective cross-sectional view of the shield assembly of FIG. 1 illustrating an example airflow; and

FIG. 5 illustrates an cross-sectional heat map of the shield assembly of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Acoustic sensors typically operate by detecting changes in sound pressure relative to an equilibrium point, such as atmospheric pressure. Such sensor's functionality, including the ability to accurately measure sound pressure, may depend on this equilibrium point remaining stable. However, local and transient changes in atmospheric pressure can occur in the presence of wind or other environmental factors. While wind is not oscillatory in the same sense as acoustic pressure, turbulence can cause localized static pressure variations.

In certain audio applications, microphones may be exposed to the atmosphere and therefore subjected to changes in atmospheric pressure. Described herein is a protective device designed to mitigate the impact of such pressure variations, ensuring the accuracy of sound pressure measurements by acoustic sensors in various atmospheric conditions.

The wind shield device described herein is designed to protect a microphone from wind or any other fluid flow, whether laminar or turbulent, while also allowing for acoustic pressures, i.e., sound, to transmit freely from one side of the shield device to the other. That is, the shield is acoustically transparent. The disclosed shield device includes two primary protective layers, each featuring multiple holes that may guide fluid flow away from the microphone. The holes also serve as channels for acoustic pressure to pass with minimal impedance. Additionally, connecting walls between the two layers may include similar holds to further facilitate the transmission of both fluid flow and acoustic pressure through the shield.

The shield device may be scalable and customized to accommodate microphones of various sizes and configurations. Further, the shield device is well-suited for use in diverse applications, including Motorcycle Active Noise Cancellation systems and consumer headphones equipped with microphones that may be exposed to wind.

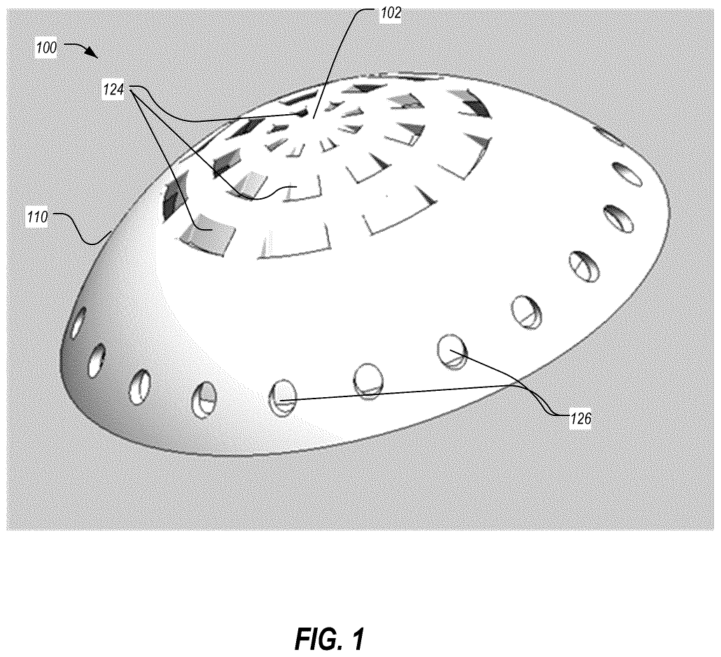

FIG. 1 illustrates a perspective top view of a shield device or shield assembly 100. The shield assembly 100 may be configured to be placed over an acoustic sensor such as a microphone or other sensor and provide protection to such component from the external environment, especially wind or other fluid flow. The shield assembly 100 may form a dome-shape or generally conical shape having an apex 102 extending to a base 104. The assembly 100 may be hallow and open at the base 104. The base 104 may form a circular perimeter. The diameter of the base 104 may depend on the size of microphone that the shield assembly 100 is arranged on. Other three-dimensional shapes such an pyramids, cuboids, etc., may also be contemplated.

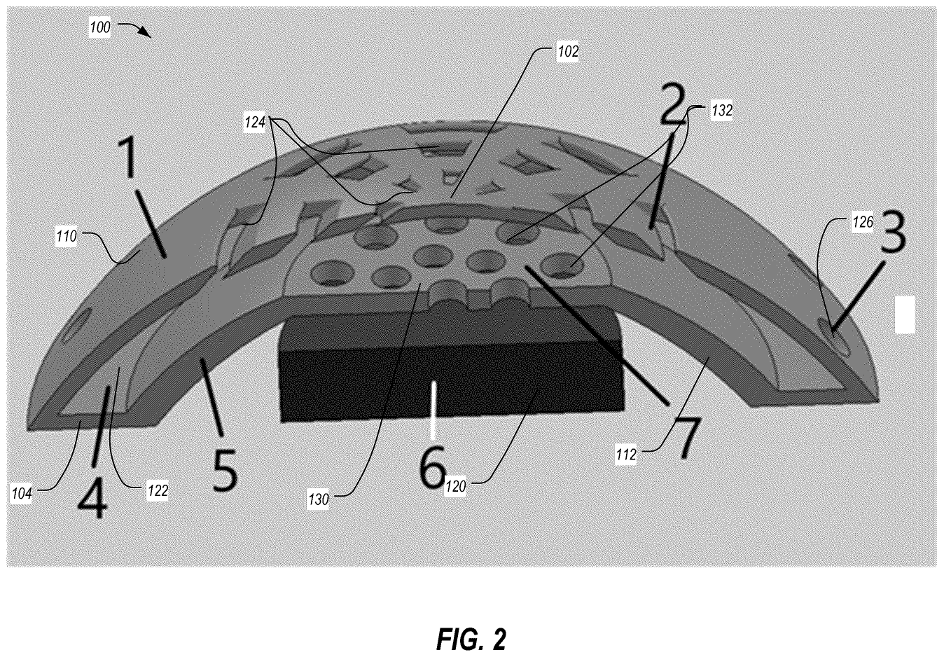

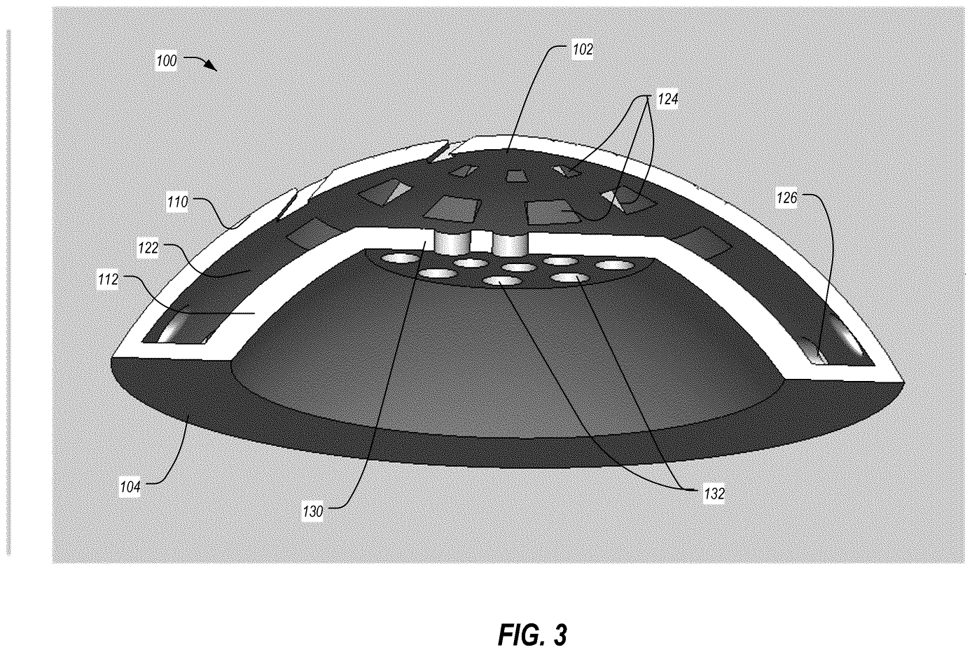

FIGS. 2 and 3 illustrate perspective cross-sectional views of the shield assembly 100 of FIG. 1 showing the underside of the shield assembly 100. The shield assembly 100 includes two shells, a first outer shell 110 and a second inner shell 112. The outer shell 110 may form the apex 102 and extend down to the base 104. The inner shell 112 may be arranged inside and spaced from the outer shell 110. The inner shell 112 may also from an inner apex 130 and extend to the base 104. The base 104 may connect the two shells 110, 112 as well as maintain the shells 110, 112 in a spaced, fixed relationship to one another.

The base 104 may be a ring-like shape. The inner shell 112 may form an interior opening configured to receive a microphone 120. The microphone 120, as explained, may be configured to convert sound waves into electrical signals. The microphone 120 functions as a transducer, capturing acoustic energy (sound) and transforming it into an electrical signal that can be amplified, processed, recorded, or transmitted. As explained, it is important to maintain the acoustic pressure to facilitate proper operation of the microphone 120.

The outer shell 110, inner shell 112 and base 104 may form a channel 122 between the outer shell 110 and inner shell 112. The channel 122 may be configured to receive and move air therein. The channel 122 may isolate the air from the microphone 120, thus protecting the microphone 120 from environmental forces.

Each of the outer shell 110 and inner shell 112 may define a plurality of openings. These openings may be configured to allow air to flow therethrough. In the example of the outer shell 110, the outer shell 110 may include a plurality of first perforations 124 arranged at and extending from the apex 102. The first perforations 124 may be openings that cascade radially outwardly and downward from the apex 102. The first perforations 124 may be arranged in radially spaced rows. This example may be best illustrated in FIG. 1. The first perforations 124 may be arranged in, for example, three rows, with a first row extending radially about the apex 102. A second row may then extend radially spaced from the first row, and the third row may be further down the outer shell 110 adjacent the second row. More or less rows, or various arrangements may also be considered.

The first perforations 124 may form a quadrilateral shape such as square or rectangle, though other shapes may be appreciated. The perforations 124 may form an angle with the outer surface of the outer shell 110. Such an angle may guide incoming air into the perforations 124 and subsequently into the channel 122. The size of the first perforation 124 may vary between the rows, as well as the spacing between adjacent perforations 124. In one example, as the perforations 124 become more distant from the apex 102, the larger or wider the perforations 124 may be.

The outer shell 110 may also define a plurality of second perforations 126. The second perforations 126 may be arranged around the base 104 and spaced from the last row of the first perforations 124. The second perforations 126 may form a ring around the base 104 and are configured to allow wind to either enter or exit the channel 122. In combination with the first perforations 124, the second perforations 126 aid to redirect air away from the microphone 120. The second perforations 126 may be circular in shape, though other shapes may be contemplated. The second perforations 126 may form a single row of equally spaced holes, in one example.

The inner shell 112, as explained and shown, may also form a dome shape and be similarly contoured and proportioned to the outer shell 110 in order to create the channel 122. The inner shell 112 may also define the inner apex 130, though the inner apex 130 may be generally flat to better accommodate the microphone 120.

The inner apex 130 may define a plurality of inner perforations 132. The inner perforations 132 may be circular in shape and may be arranged in a radial pattern around the inner apex 130. The inner perforations 132 may allow acoustic pressure to pass through and reach the microphone 120 arranged under the inner apex 130. The acoustic pressure may transfer from the outside environment to the microphone 120 through the outer shell perforations 124, 126. However, wind that enters the inner shell 112 is redirected through the channel 122 and exited back to the external environment through the outer perforations 124, 126. This allows for effective isolation of the microphone 120 from wind, while maintaining the accurate detection of acoustic pressures.

The shield assembly 100 may be made from plastic, such as a thermoplastic. This may include polyethylene, polypropylene, thermosets including resin. Silicones and other elastomers may also be used, as well as nylons, polytetrafluoroethylene, acrylics, etc. The outer shell 110, inner shell 112 and base 104 may be formed of a single piece, or may be multiple pieces joined together.

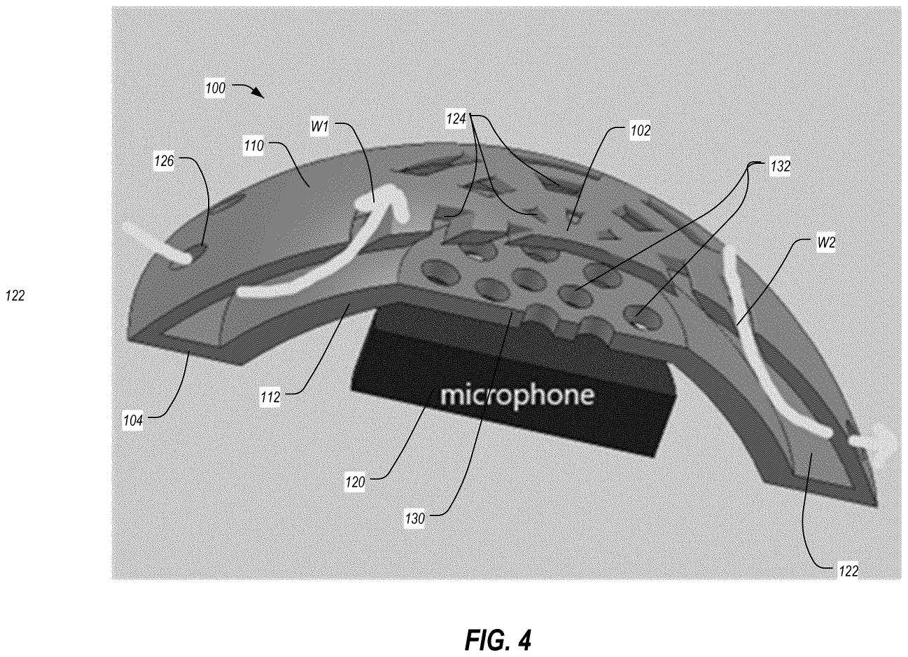

FIG. 4 illustrates another perspective cross-sectional view of the shield assembly 100 of FIG. 1 illustrating an example airflow. The airflow may be wind caused by external environments and weather, as well as airflow created by motion, acceleration, etc., of the microphone 120. A first example airflow W1 is illustrated in FIG. 4. In this example, the airflow W1 is received by one of the second perforations 126 of the outer shell 110. The airflow W1 then enters the channel 122 and then exits the channel 122 at one of the first perforations 124. The airflow W1 is guided out of the channel 122 via the angle of the first perforation 124.

In another example, a second airflow W2 may enter the shield assembly 100 at one of the first perforations 124, move through the channel 122, and exit through one of the second perforations 126. In this example, the angle of the first perforation 124 guides the airflow W2 into the channel 122. Thus, wind may enter one or both of the first and second perforations 124, 126, and be redirected out of the channel 122. In addition to receiving and passing wind therethrough, the perforations 124, 126 may also allow sound to pass through to the microphone 120.

It should be noted that the outer shell 112 may include more perforations to allow sound to pass through to the microphone, as well as to receive the airflow/wind. The orientation of the angled perforations (e.g., the first perforation 124) may be relative to any axis, but also may facilitate guiding airflow therethrough. The outer shell is configured to direct wind away from the microphone by directing it into the channel 122. The inner shell 112 aids in further separating the microphone 122 from the wind, but the inner perforations 132 allow sound to still be received by the microphone.

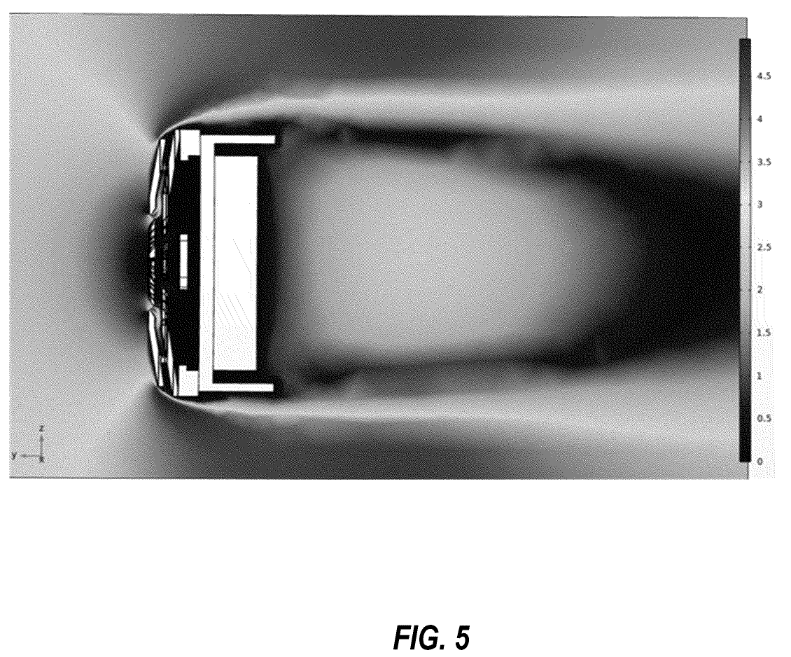

FIG. 5 illustrates a cross-sectional heat map of the velocity of air across the shield assembly 100 of FIG. 1. As illustrated, the air velocity is higher around the shield assembly 100, as well as within the channel 122. However, air velocity is lower at and around the microphone 120, thus indicating the decrease in environmental effect on the microphone 120 due to the shield assembly 100.

Accordingly, described herein is a multi-layered shield for protecting microphones from wind. The shield has a dome-shaped structure or a similar shape. The apex of the dome, which is the point furthest away from the base, serves as the side of the shield that attaches to the rest of the system. This shield effectively isolates the microphone from external forces such as wind.

A secondary dome-shaped (or similarly contoured) shield is positioned between the outer layer and the microphone. Together, these two layers form a channel that allows fluid, such as wind, to flow through. The base of the outer layer includes a ring of perforations that enable wind to enter or exit the channel between the layers. Additionally, the apex of the outer layer is perforated, with the perforations angled in such a way that wind entering through them is guided downward along the channels and exits through the perforations at the base ring of the outer layer.

The apex of the inner layer is also perforated, allowing acoustic pressure to pass through and reach the microphone located between the inner shield and the system base. Acoustic pressure is transferred from the outside environment to the space between the two shield layers via either the ring of perforations at the base or the apex perforations of the outer layer. It then passes through the perforations in the apex of the inner layer to reach the microphone.

Any wind transferred to the inner layer is redirected through the channel formed between the two shield layers and exits back to the outside environment via the perforations in the outer layer. This structure ensures that the microphone is effectively shielded from wind while maintaining its ability to detect acoustic pressure accurately.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A shield assembly arranged around an acoustic sensor, comprising:
an outer shell extending from an outer apex to a base and forming a dome-shape, the outer shell defining at least one perforation to allow air to flow therethrough; and
a inner shell extending from an inner apex to the base inside of the outer shell, the inner shell creating a channel between the outer shell, inner shell, and base to receive airflow at the at least one perforation, wherein the at least one perforation and channel redirect air to protect a microphone arranged within the inner shell from external airflow and preserving sound pressure measurement integrity.

2. The assembly of claim 1, wherein the at least one perforation includes a plurality of first perforations and a plurality of second perforations, wherein the first perforations extend radially from the apex and wherein the second perforations are spaced from the first perforations, wherein when the airflow is received at at least one of the first perforations, the airflow travels through the channel and out of at least one of the second perforations, and wherein when the airflow is received at at least one of the second perforations, the airflow travels through the channel and out of at least one of the first perforations.

3. The assembly of claim 2, wherein the second perforations are spaced from the first perforations and include a plurality of spaced holes around the base forming a ring of perforations.

4. The assembly of claim 2, wherein the first perforations are defined at an angle to facilitate receiving the airflow.

5. The assembly of claim 2, wherein the first perforations each form a quadrilateral.

6. The assembly of claim 2, wherein the first perforations include a plurality of rows of perforations, each spaced from the next row radially downward from the apex.

7. The assembly of claim 1, wherein the inner shell defines a plurality of inner perforations at the inner apex to allow sound to pass to the microphone.

8. The assembly of claim 1, wherein the base maintains the outer shell and inner shell in fixed relationship to each other to form the channel therebetween.

9. A shield assembly arranged around an acoustic sensor, comprising:
an outer shell extending from an outer apex to a base and forming a dome-shape, the outer shell defining a plurality of perforations, including a plurality of first perforations and a plurality of second perforations,
wherein the first perforations extend radially from the apex and are defined at an angle within the outer shell to receive airflow from the environment external to the outer shell,
wherein the second perforations are spaced from the first perforations and include a plurality of spaced holes around the base forming a ring of perforations, and
wherein when the airflow is received at at least one of the first perforations, the airflow flows out of at least one of the second perforations, and wherein when the airflow is received at at least one of the second perforations, the airflow flows out of at least one of the first perforations.

10. The assembly of claim 9, further comprising an inner shell extending from an inner apex to the base inside of the outer shell, the inner shell creating a channel between the outer shell, inner shell, and base to receive airflow at the first and second perforation of the outer shell to protect the sensor arranged from external airflow and preserving sound pressure measurement integrity.

11. The assembly of claim 10, wherein the inner shell defines a plurality of inner perforations at the inner apex to allow sound to pass to the sensor.

12. The assembly of claim 10, wherein the base maintains the outer shell and inner shell in fixed relationship to each other to form the channel therebetween.

13. The assembly of claim 9, wherein the first perforations each form a quadrilateral.

14. The assembly of claim 9, wherein the first perforations include a plurality of rows of perforations, each spaced from the next row radially downward from the apex.
